(19) United States
(12) Patent Application Publication
(10) Pub. No.: US 2012/0296902 A1
(43) Pub. Date: Nov. 22, 2012

(54) SYSTEM AND METHOD FOR IDENTIFYING THE PRINCIPAL DOCUMENTS IN A DOCUMENT SET

(76) Inventors: Vinay Deolalikar, Capertino, CA (US); Hernan Laffitte, Mountain View, CA (US)

(21) Appl. No.: 13/383,592

(22) PCT Filed: Feb. 13, 2010
(86) PCT No.: PCT/US10/24200

§ 371 Date: Jan. 12, 2012

(51) Int. Cl. G06F 17/30

(52) U.S. Cl. 707/737; 707/E17.089

(57) ABSTRACT

A method (200) of identifying a principal document in a document set is provided. An exemplary method includes obtaining a document set comprising a plurality of documents (202) and grouping the plurality of documents into a plurality of clusters based, at least in part, on a textual similarity between each of the plurality of documents (204). The method also includes obtaining one or more descriptive terms corresponding to the plurality of documents, wherein the descriptive terms are terms within the plurality of documents that have been identified as being useful for discriminating between the clusters (206). The method also includes, for each cluster, identifying a subset of descriptive terms based, at least in part, on a prevalence of the descriptive terms within the documents of the cluster (208) and identifying the principal documents in the cluster based, at least in part, on a prevalence of the subset of descriptive terms within each of the documents in the cluster (210).

### BACKGROUND

Managing large numbers of electronic documents in a data storage system can present several challenges. A typical data storage system may store a document set that includes thousands of documents or more, many of which may be related in some way. For example, in some cases, a document may serve as a template which various people within the enterprise adapt to fit existing needs. In other cases, a document may be updated over time as new information is acquired or the current state of knowledge about a subject evolves. In some cases, several documents may relate to a common subject and may borrow text from common files.

As a result, there may be several documents in a document set that relate to similar subject matter. However, the relative importance of those documents may vary. For example, one or more documents may provide a more thorough coverage of a particular subject matter, while other documents in the set may provide only partial or incomplete coverage of the same subject matter. Often times, a reader may be interested in reading only one or a few of the more important documents on a particular subject. Due to the large volume of documents that may be included in a document set, manually determining the content of the documents and assessing the relative importance of those documents may involve considerable time and effort.

### BRIEF DESCRIPTION OF THE DRAWINGS

Certain exemplary embodiments are described in the following detailed description and in reference to the drawings, in which:

FIG. 1 is a block diagram of a computer network in which a client system can access a document resource, in accordance with an exemplary embodiment of the present invention;

FIG. 2 is a process flow diagram of a method of identifying the principal documents in a document set, in accordance with an exemplary embodiment of the present invention;

FIG. 3 is a block diagram of a document collection system that uses the principal documents algorithm, in accordance with an exemplary embodiment of the present invention; and

FIG. 4 is a block diagram showing a tangible, machine-readable medium that stores code adapted to identify the principal documents in a document set, in accordance with an exemplary embodiment of the present invention.

### DETAILED DESCRIPTION

As used herein, the term “exemplary” merely denotes an example that may be useful for clarification of the present invention. The examples are not intended to limit the scope, as other techniques may be used while remaining within the scope of the present claims. Exemplary embodiments of the present invention provide techniques for automatically identifying the principal documents within a document set. As used herein, a “principal document” refers to document within a document set that provides a more complete or thorough coverage of a particular topic or subject matter compared to other documents in the document set. Automatically identifying the principal documents in a document set may save considerable time and effort that may otherwise be used in manually assessing the subject matter and relative importance of the documents in the document set.

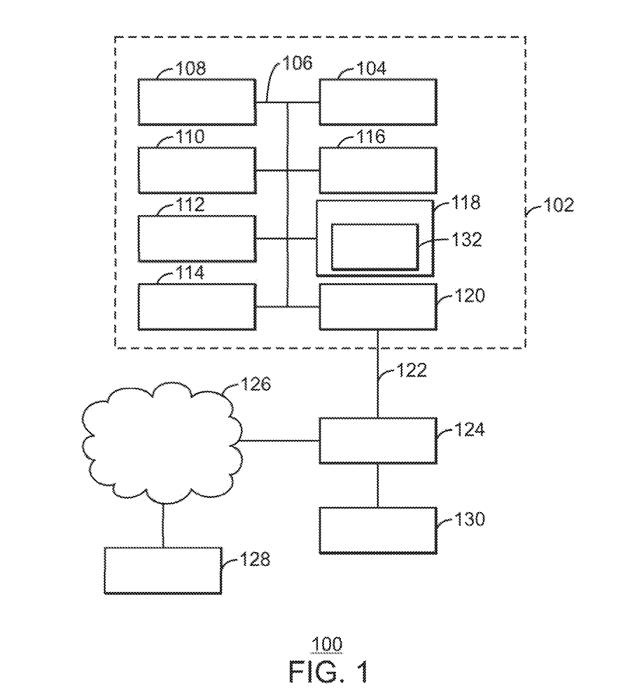

Methods and systems that enable the automatic identification of the principal documents in a document set may have many uses. In some exemplary embodiments, a system that identifies the principal documents in a document set may be used in research to identify those documents that are more likely to containing subject matter of interest. For example, a system for identifying principal documents may be used in educational research, scientific research, legal research, electronic discovery, and the like. In another exemplary embodiment, a method for identifying principal documents may be used to store the more important or representative documents with regard to a particular subject matter to an information warehouse. This may save time and labor over manual sorting, which would otherwise be used to assess document's relative importance compared to other documents in the document set. As used herein, the term “automatically” is used to denote an automated process performed, for example, by a machine such as the client system 102 discussed with respect to FIG. 1. It will be appreciated that various processing steps may be performed automatically even if not specifically referred to herein as such.

FIG. 1 is a block diagram of a computer network in which a client system can access a document resource, in accordance with an exemplary embodiment of the present invention. The computer network may be referred to by the reference number 100 and includes a client system 102 in communication with one or more document resources. As used herein, the document resource may be any device or system that provides a set of documents, for example, disk drive, storage array, an electronic mail server, search engine, and the like. As illustrated in FIG. 1, the client system 102 will generally have a processor 104, which may be connected through a bus 106 to a display 108, a keyboard 110, and one or more input devices 112, such as a mouse or touch screen. The client system 102 can also have an output device, such as a printer 114 operatively coupled to the bus 106.

The client system 102 can have other units operatively coupled to the processor 104 through the bus 106. These units can include tangible, machine-readable storage media, such as a storage system 116 for the long-term storage of operating programs and data, including the programs and data used in exemplary embodiments of the present techniques. The storage system 116 may include, for example, a hard drive, an array of hard drives, an optical drive, an array of optical drives, a flash drive, or any other tangible storage device. Further, the client system 102 can have one or more other types of tangible, machine-readable storage media, such as a memory 118, for example, which may comprise read-only memory (ROM) and/or random access memory (RAM). In exemplary embodiments, the client system 102 will generally include a network interface adapter 120, for connecting the client system 102 to a network 122, such as a local area network (LAN), a wide-area network (WAN), or another network configuration. The LAN can include routers, switches, modems, or any other kind of interface device used for interconnection.

Through the network interface adapter 120, the client system 102 can connect to a server 124. The server 124 may enable the client system 102 to connect to the Internet 126. For example, the client system 102 can access a search engine 128 connected to the Internet 126. In exemplary embodiments of the present invention, the search engine 128 may include generic search engines, such as GOOGLE™, YAHOO®, BING™, and the like. In other embodiments, the search engine 128 may be a specialized search engine that enables the client system 102 to access a specific document set provided by a specific on-line entity. For example, the search engine 128 may provide access to documents provided by a professional organization, governmental body, business entity, public library, and the like.

The server 124 can also have a storage array 130 for storing enterprise data. The enterprise data may provide a document resource to the client system 102 by including a plurality of stored documents, such as ADOBE® Portable Document file (PDF) documents, spreadsheets, presentation documents, word processing documents, database files, MICROSOFT® Office documents, Web pages, Hypertext Markup Language File (HTML) documents, eXtensible Markup Language (XML) documents, plain text documents, electronic mail files, optical character recognition (OCR) transcriptions of scanned physical documents, and the like. Furthermore, the documents may be structured or unstructured. As used herein, a set of “structured” documents refers to documents that have been related to one another by a tracking system that records the evolution of the documents from prior versions. However, in embodiments in which the documents are structured, the recorded relationship between documents may be ignored.

Those of ordinary skill in the art will appreciate that business networks can be far more complex and can include numerous servers 130, client systems 102, storage arrays 136, and other storage devices, among other units. Moreover, the business network discussed above should not be considered limiting as any number of other configurations may be used. Any system that allows a client system 102 to access a document resource, such as the storage array 130 or an external document storage, among others, should be considered to be within the scope of the present techniques.

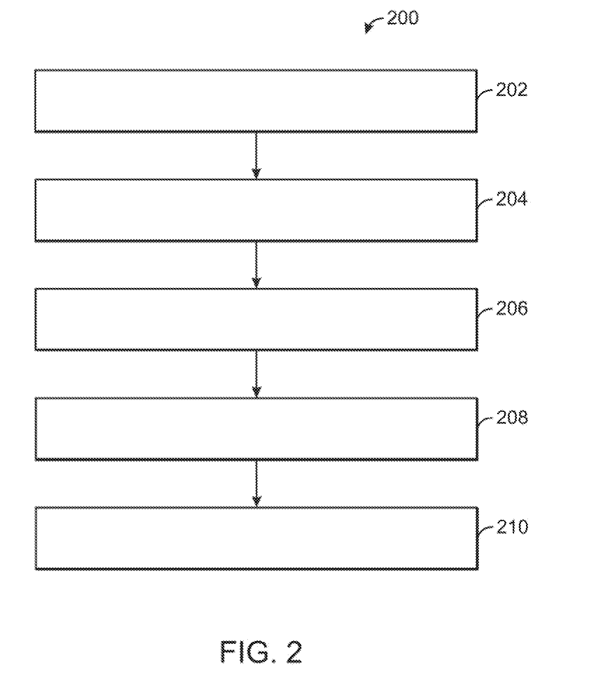

In exemplary embodiments of the present invention, the memory 118 of the client system 102 may hold a document analysis tool 132 for analyzing electronic documents, for example, documents stored on the storage system 116 or storage array 130, documents available through the search engine site 128, or any other document resource accessible to the client system 102. The document analysis tool 132 may obtain a group of documents, referred to herein as a “document set,” which may include any suitable group of documents available through one of more of the document resources. As described further below in reference to FIG. 2, the document set may be selected by a user or defined automatically.

Upon obtaining the document set, a principal documents query may be initiated through the document analysis tool 132, for example, automatically or by a user. In response to the principal documents query, the document analysis tool 132 identifies one or more principal documents in the document set. In some exemplary embodiments, the principal documents may be identified using a data mining technique known as “clustering.” Documents may be clustered according to the textual similarities or dissimilarities of the documents. Each generated cluster may represent a group of documents that are textually similar enough to be considered to relate to the same topic. One or more of the generated clusters may then be individually processed to identify one or more principal documents, which are identified as representing a more thorough discussion of the topic represented in the cluster. A method of identifying the principal documents may be better understood with reference to FIG. 2.

FIG. 2 is a process flow diagram of a method of identifying the principal documents in a document set, in accordance with an exemplary embodiment of the present invention. The exemplary method described herein may be performed, for example, by the document analysis tool 132 operating on the client system 102. The method may be referred to by the reference number 200 and may begin at block 202, wherein a document set is obtained. The document set may include any suitable grouping of the documents accessible to the client system 102 through one of more of the document resources, for example, the storage array 130, the storage system 116, or any other document resource accessible to the client system 102 such as the search engine site 128. The document set may include any suitable type of documents, for example, MICROSOFT® Office documents, electronic mail files, plain text documents, HTML documents, ADOBE® Portable Document File (PDF) documents, Web pages, scanned OCR documents, and the like.

In some exemplary embodiments, the document set may be defined automatically. For example, the document set may include all of the documents on the user's computer, or within a specific file directory or disk drive partition on the user's computer. The automatically defined document set may also include files of a particular type, for example, MICROSOFT® OFFICE files, PDFs among others. In some exemplary embodiments, the user may define the document set, for example, by selecting a particular file location such as a particular directory or disk drive. Furthermore, the user may define the document set as including files with a common file characteristic, for example, the same file type, the same file extension, a specified string of characters in the file name, files created after a specified data, and the like. To enable the user to select the document set, the data analysis tool may generate a graphical user interface (GUI), which may be displayed on the display 108 (FIG. 1). In such embodiments, the GUI may also enable the user to initiate the principal documents query.

At block 204, the documents of the document set may be grouped into clusters based on a textual similarity of the documents. As noted above, the generation of the clusters may be accomplished using a clustering algorithm, which may be included in the document analysis tool 132. Clustering the documents may begin by generating a feature vector for each document in the document set. The feature vector may be used to compare the textual content of the documents and identify similarities or dissimilarities between documents. The feature vector may be generated by scanning each document and identifying individual terms or phrases, referred to herein as “tokens,” occurring in the document. Each time a token is identified in the document, an element in the feature vector corresponding to the token may be incremented. Each element in the feature vector may be referred to herein as a “token frequency.” Each feature vector may include a token frequency element for each token represented in the document set. The feature vector of a document may be represented by the following formula:

V_{D}^{tf-idf}:=(tf₁,tf₂, . . . , tf_{T})

In the above formula, V_{D}^{tf} refers to the frequency with which the t^{th} term in the document set occurs in the document and T equals the total number of tokens in the document set.

In some exemplary embodiments, each token frequency of the feature vector is multiplied by a global weighting factor that corresponds with a characteristic of the entire document set. The same global weighting factor may be applied to the feature vector of each document in the document set. In some embodiments, the global weighting factor may be an inverse document frequency (idf), which is the inverse of the fraction of documents in the document set that contain a given token. In such embodiments, the resulting weighted feature vector may be represented by Equation (1):

$${V}_{D}^{tf - idf} := ( {tf}_{1} log \frac{\vert U \vert}{{df}_{1}} , {tf}_{2} log \frac{\vert U \vert}{{df}_{2}} , … , {tf}_{T} log \frac{\vert U \vert}{{df}_{T}} ) \qquad ( 1 )$$

In the above formula, V_{D}^{tf-idf} is the feature vector multiplied by the inverse document frequency, |U| equals the number of documents in the document set, and df₁ is the number of documents in the document set that contain the t^{th} token. Additionally, each of the weighted token frequencies of the weighted feature vector may be normalized to have unit magnitude, for example, a magnitude between 0 and 1.

Continuing at block 204, the documents in the document set may be grouped into clusters based on a degree of textual similarity between the documents as represented by the feature vectors. To determine the degree of textual similarity between the documents, a similarity value may be computed for each pair of feature vectors generated for the documents in the document set. To group the documents into clusters, the clustering algorithm segments the documents in the document set into a plurality of clusters based on the similarity value. In some exemplary embodiments, the similarity value may be a Cosine similarity computed according to the formula shown in Equation (2):

$$s ( {D}_{i} , {D}_{j} ) := cos ( {V}_{{D}_{i}} , {V}_{{D}_{j}} ) = \frac{{V}_{{D}_{i}} \cdot {V}_{{D}_{j}}}{‖ {V}_{{D}_{i}} ‖ ‖ {V}_{{D}_{j}} ‖} \qquad ( 2 )$$

In Eqn. 2, s(Dᵢ,Dⱼ) represents the similarity value for the documents Dᵢ and Dⱼ, V_{D}_{ᵢ}·V_{D}_{ⱼ} is the dot product of the feature vectors corresponding to the documents Dᵢ and Dⱼ, and ∥V_{D}_{ᵢ}∥∥V_{D}_{ⱼ}∥ is the product of the magnitudes of the feature vectors corresponding to the documents Dᵢ and Dⱼ.

Any suitable clustering algorithm may be used to group the selected documents into clusters, for example, a k-means algorithm, a repeated bisection algorithm, a spectral clustering algorithm, an agglomerative clustering algorithm, and the like. These techniques may be considered as either additive or subtractive. The k-means algorithm is an example of an additive algorithm, while a repeated-bisection algorithm may be considered as an example of a subtractive algorithm.

In a k-means algorithm, a number, k, of the documents may be randomly selected by the clustering algorithm. Each of the k documents may be used as a seed for creating a cluster and serve as a representative document, or “cluster head,” of the cluster until a new document is added to the cluster. Each of the remaining documents may be sequentially analyzed and added to one of the clusters based on a similarity between the document and the cluster head. Each time a new document is added to a cluster, the cluster head may be updated by averaging the feature vector of the cluster head with the feature vector of the newly added document.

In a repeated-bisection algorithm, the documents may be initially divided into two clusters based on dissimilarities between the documents, as determined by the similarity value. Each of the resulting clusters may be further divided into two clusters based on dissimilarities between the documents in each cluster. The process may be repeated until a secondary set of smaller clusters is generated.

Furthermore, to generate the clusters a cluster granularity, N, may be determined. The cluster granularity, N, represents an average cluster size, in other words, an average number of documents that may be grouped into the same cluster by the clustering algorithm. The cluster granularity may be determined based on a number of expected subject matter topics represented in the document set. For example, the cluster granularity may be determined such that the number of dusters generated equals the number of expected topics. In some exemplary embodiments, an average cluster size may be approximately 100 to 1,000 documents. The number of expected subject matter topics may be specified by a user or determined heuristically based on the types of documents in a set. For example, if the documents have been generated by researchers in a laboratory, it may be estimated that each researcher participates in one to two projects per year, each project lasting about five years. Based on these assumptions, it may be estimated that over a period of 5 years, the researchers together may have participated in approximately 50 projects. Thus, the number of expected topics may be approximately fifty.

In some cases, depending on the number of documents in the document set and the number of expected topics, a large number of relatively small clusters of less than 100 documents may be generated. In some exemplary embodiments, a two-stage clustering algorithm may be used to reduce the time and processing resources used to generate the clusters. In a first stage of the two-stage clustering algorithm, the documents in the document set may be grouped into coarse clusters as discussed above, using an initial coarse cluster granularity. In some exemplary embodiments, the coarse granularity may be specified by a user. In other exemplary embodiments, the coarse granularity may be automatically determined by the clustering algorithm as a fraction of the number of documents in the document set and depending on the processing resources available to the client 102. The user may select one of the coarse clusters for further processing based on the subset of documents included in the selected coarse cluster. During a second stage of the clustering algorithm the documents of the selected coarse cluster may then be further grouped into a secondary set of smaller clusters using a specified fine cluster granularity that is based on the number of expected topics represented in the selected coarse cluster.

Each of the resulting clusters may include documents that have a high degree of textual similarity with each other. After generating the clusters, each cluster may be further processed as described below to identify one or more principal documents in each cluster. In exemplary embodiments in which a two-stage clustering algorithm is employed, the set of secondary clusters are further processed as described below while the initial set of coarse clusters may be ignored.

At block 206, a single cluster is selected and a list of descriptive terms is obtained for the cluster. The list of descriptive terms is provided by the clustering algorithm and represents the set of terms that tended to occurred more frequently within the document set and have been identified by the clustering algorithm as being relatively more useful, compared to other terms, for discriminating between clusters. In one exemplary embodiment, the list of descriptive terms may include the top 20 terms that were found to be more useful in generating the clusters, however, a larger or smaller number of descriptive terms may be used.

In some exemplary embodiments, the descriptive terms may then be used to generate a matrix that can be processed to identify the principal documents. The rows of the matrix may correspond to documents in the cluster, and the columns of the matrix may correspond to the descriptive terms obtained for the cluster. Each entry in the matrix may correspond to the number of times that the corresponding descriptive term appears in the corresponding document. In other words, the (i, j)^{th} entry is the number of times that the descriptive term Tⱼ occurs in the document Dᵢ. The matrix may be thought of as representing a bipartite graph between the documents in a cluster and the descriptive terms of that cluster, wherein a document is linked by an edge to a descriptive term if the term occurs in the document and the weight of this edge is the number of times that the term occurs in the document.

In some exemplary embodiments, the entries in each column of the matrix may be multiplied by the information gain of the descriptive term corresponding to the column. The information gain may be provided by the clustering algorithm and represents the relative importance of the corresponding descriptive term in generating the clusters. In some embodiments, the information gain may be computed as the frequency with which the descriptive term occurs in members of the cluster divided by the frequency with which the term occurs in the document set as a whole.

At block 208, a subset of descriptive terms is identified based on the prevalence of the descriptive terms within the cluster. For example, the subset of descriptive terms may include one or more descriptive terms that occur more often within the cluster compared to other descriptive terms in the cluster. To identify the subset of descriptive terms, a threshold weight, W, may be specified. Each column of the matrix may then be summed and compared to the threshold weight. Those descriptive terms whose corresponding sum is greater that the threshold weight may be added to the subset of descriptive terms. In some exemplary embodiments, the threshold weight, W, may be specified as a percentage of the total weight of the descriptive terms. For example, if the threshold weight is specified as 85 percent, the subset of descriptive terms will include only those descriptive terms that contribute 85 percent of the total weight assigned to the descriptive terms by the clustering algorithm.

At block 210, the principal documents may be identified for the cluster based on the prevalence of the subset of descriptive terms within the documents. In some exemplary embodiments, a document score may be generated by summing the row of the matrix corresponding to the document using only the columns corresponding to the subset of descriptive terms identified in block 208. The documents with higher document scores may be identified as principal documents. For example, in one embodiment, a single principal document may be identified for each cluster, in which case, the document with the largest document score may be identified as the principal document. In other embodiments, the document scores may be ranked and a specified number of documents with the largest document scores may be identified as principal documents. In an exemplary embodiment, a document score threshold may be specified such that all documents with document scores above the threshold are identified as principal documents. The score threshold may be specified as a percentage of the highest value that occurs in the cluster. For example, if the score threshold is specified as 85 percent and the highest document score of a document in the cluster is 100, then all documents with a document score above 85 may be identified as principal documents.

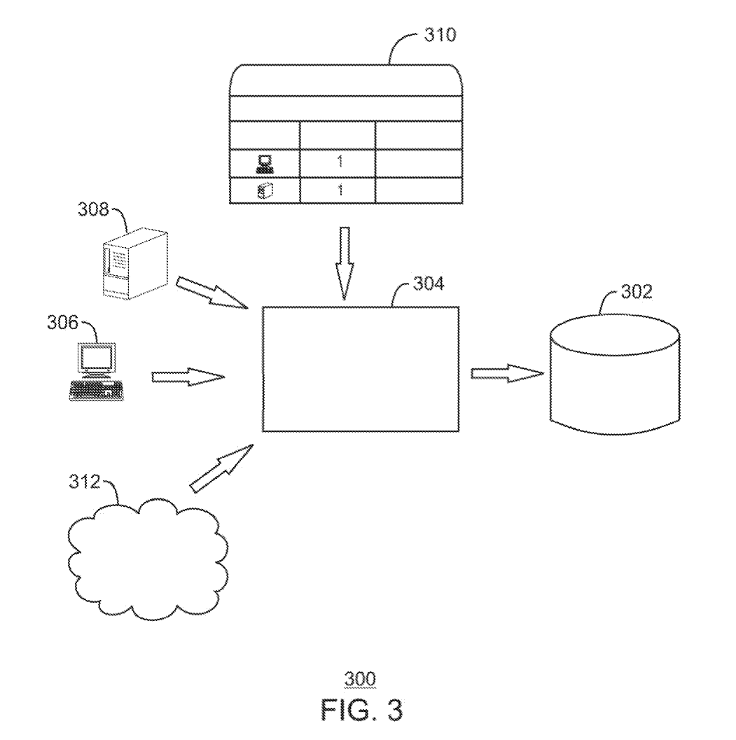

The number of principal documents identified may depend on the design considerations of a particular implementation of the techniques described herein. In some exemplary embodiments, the user may specify a number of principal documents desired, which may be different for different principal documents queries. For example, in some embodiments, a user may want to identify the principal documents within a document set in order to become personally familiar with a particular subject matter. In this embodiment, the user may specify a small number of principal documents desired based on the amount of the amount of time the user has available to read the documents, for example, one, two, or three principal documents per cluster. In another embodiment, the principal documents query may be generated automatically, for example, to periodically identify and flag documents to be included in an information warehouse, which is described further in relation to FIG. 3. In this embodiment, the number of principal documents desired may be specified by an administrator of the document warehouse, based on the available storage capacity of the document warehouse and the number of document resources providing documents to the document warehouse. In another exemplary embodiment, the principal documents algorithm may be used in legal discovery to identify documents that may be useful in a lawsuit. In such an embodiment, the, user may specify a large number of principal documents desired, for example, 10 to 20 documents per cluster. In this way, the principal documents identified may represent a more thorough representation of the subject matter included in the document set.

Blocks 206 to 210 may be repeated for each cluster generated at block 204. In some exemplary embodiments, the results of the principal documents algorithm may used to generate a visual display viewable by the user, for example, the GUI generated on the display 108 (FIG. 1). In such embodiments, a document identifier, such as a document name, may be displayed for each of the principal documents along with other document information such as document location, creation date, a document summary, and the like. Furthermore, the principal documents that belong to the same cluster may be grouped together in the display and ranked according to document score. In some exemplary embodiments, the principal documents may be automatically copied or moved to another storage location without manual intervention, as described below in reference to FIG. 3.

FIG. 3 is a block diagram of a document collection system that uses the principal documents algorithm, in accordance with an exemplary embodiment of the present invention. The document collection system 300 may include an information warehouse 302 communicatively coupled to a document staging area 304. The staging area 304 may exist, for example, on a general-purpose computer configured to receive documents from a variety of document resources. In an exemplary embodiment, this may be the client system 102 discussed with respect to FIG. 1. As shown in FIG. 3, the document resources may include one or more personal computers 306, a shared document storage server 308, an enterprise database 310 such as a sales database, and the like. The document resources may also include document resources sources available through the Internet 312, for example, competitor's Websites, financial Websites, and the like. Each of the document resources may include a document analysis tool 132 (FIG. 1) that executes the principal documents algorithm as a background process without substantial user involvement. For example, the principal documents algorithm may be programmed to execute periodically, for example, daily, weekly, monthly, and the like.

The principal documents identified by the document analysis tool 132 may then be sent from each of the document resources to the staging area 304. The staging area 304 may be used to organize and structure the documents before storing the documents to the information warehouse 302. For example, in some embodiments, the principal documents may be converted to a common document format, and annotated with additional information such as the document source, author, date that the document was received in the staging area, and the like. If the document is related to another principal document previously received at the staging area 304 or already stored in the information warehouse 302, for example, at earlier version of the same document, the document may be annotated to identify the previous document. In some embodiments, the principal documents may be cross-indexed to provide fast query response times to users that subsequently search the information warehouse. Additionally, the documents may also be encrypted or password protected to increase document security. After processing the principal documents at the staging area 304, the documents may be added to the information warehouse 302. The information warehouse may be implemented in any suitable type of electronic storage device. Methods of generating and maintaining an information warehouse will be recognized by those of ordinary skill in the art.

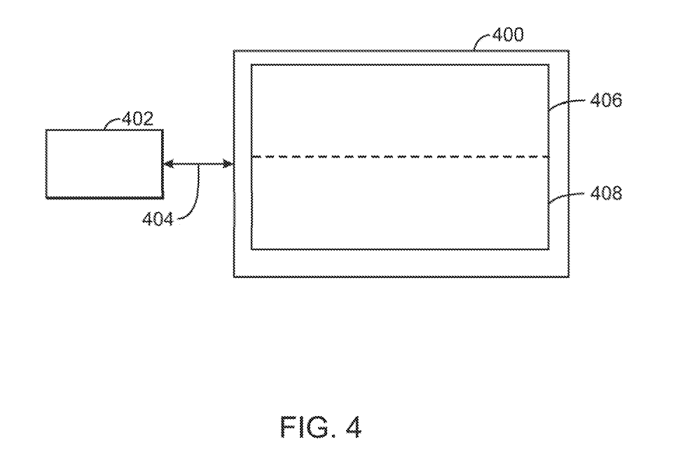

FIG. 4 is a block diagram showing a tangible, machine-readable medium that stores code adapted to identify the principal documents in a document set, in accordance with an exemplary embodiment of the present invention. The tangible, machine-readable medium is generally referred to by the reference number 400. The tangible, machine-readable medium 400 can comprise RAM, a hard disk drive, an array of hard disk drives, an optical drive, an array of optical drives, a non-volatile memory, a USB drive, a DVD, or a CD, among others. Further, the tangible, machine-readable medium 400 can comprise any combinations of media. In one exemplary embodiment of the present invention, the tangible, machine-readable medium 400 can be accessed by a processor 402 over a computer bus 404.

As shown in FIG. 4, the various exemplary components discussed herein can be stored on the tangible, machine-readable medium 400 and included in one or more instruction modules. As used herein, a “module” is a group of processor-readable instructions configured to instruct the processor to perform a particular task. For example, a first module 406 on the tangible, machine-readable medium 400 may store a cluster generator configured to group a plurality of documents into a plurality of clusters based on a textual similarity between the plurality of documents. A second module 408 can include a principal documents identifier configured to obtain one or more descriptive terms corresponding to the plurality of documents, wherein the descriptive terms have been identified by the cluster generator as being useful for discriminating between clusters. The principal document identifier may also identify a subset of descriptive terms for one of the plurality of clusters based, at least in part, on a prevalence of the descriptive terms within the documents of the cluster. The principal documents identifier may also identify the principal documents in the cluster based, at least in part, on a prevalence of the subset of descriptive terms within each of the documents in the cluster.

Although shown as contiguous blocks, the modules can be stored in any order or configuration. For example, if the tangible, machine-readable medium 400 is a hard drive, the software components can be stored in non-contiguous, or even overlapping, sectors. Additionally, one or more modules may be combined in any suitable manner depending on design considerations of a particular implementation. Furthermore, modules may be implemented in hardware, software, or firmware.

What is claimed is:

1. A method (200) of identifying a principal document in a document set, comprising:
obtaining a document set comprising a plurality of documents (202);
grouping the plurality of documents into a plurality of clusters based, at least in part, on a textual similarity between each of the plurality of documents (204);
obtaining one or more descriptive terms corresponding to the plurality of documents, wherein the descriptive terms are terms within the plurality of documents that have been identified as being useful for discriminating between the clusters (206); and,
for each cluster:
identifying a subset of descriptive terms based, at least in part, on a prevalence of the descriptive terms within the documents of the cluster (208); and
identifying the principal documents in the cluster based, at least in part, on a prevalence of the subset of descriptive terms within each of the documents in the cluster (210).

2. The method of claim 1, wherein grouping the plurality of documents into the plurality of clusters (204) comprises generating a plurality of coarse clusters using a coarse granularity and further grouping a selected coarse cluster into secondary clusters using a fine cluster granularity.

3. The method of claim 1, comprising generating a matrix for each cluster, wherein rows of the matrix correspond to the documents in the cluster, columns of the matrix correspond to the descriptive terms, and each entry in the matrix corresponds to a number of times that a corresponding descriptive term occurs in a corresponding document.

4. The method of claim 3, comprising multiplying each entry in the matrix by an information gain of a corresponding descriptive term, wherein the information gain is a frequency with which the corresponding descriptive term occurs in members of the cluster divided by a frequency with which the corresponding descriptive term occurs in the document set as a whole.

5. The method of claim 3, wherein identifying the principal documents in the cluster (210) comprises generating a document score by summing each row of the matrix using only those columns that correspond with the subset of descriptive terms and comparing a result of the summation to a threshold.

6. A computer system (102), comprising:
a processor (402) that is adapted to execute machine-readable instructions; and
a storage device (400) that is adapted to store data, the data comprising a plurality of documents and instruction modules that are executable by the processor, the instruction modules comprising:
a cluster generator (406) configured to group the plurality of documents into a plurality of clusters based, at least in part, on a textual similarity between the plurality of documents (204); and
a principal documents identifier (408) configured to:
obtain one or more descriptive terms corresponding to the plurality of documents, wherein the descriptive terms have been identified by the cluster generator as being useful for discriminating between clusters (206);
identify a subset of descriptive terms for one of the plurality of clusters based, at least in part, on a prevalence of the descriptive terms within the documents of the cluster (208); and
identify the principal documents in the cluster based, at least in part, on a prevalence of the subset of descriptive terms within each of the documents in the cluster (210).

7. The computer system of claim 6, wherein the cluster generator (406) is configured to perform a two-stage clustering process for generating the clusters, wherein:
a first clustering stage comprises grouping the plurality of documents into a plurality of coarse clusters based, at least in part, on a textual similarity between the plurality of documents; and
a second clustering stage comprises grouping the documents in one of the coarse clusters into the plurality of clusters.

8. The computer system of claim 6, wherein the principal documents identifier (408) is configured to generate a matrix for each cluster, wherein:
rows of the matrix correspond to the documents in the cluster;
columns of the matrix correspond to the descriptive terms; and
each entry in the matrix corresponds to a number of times that the corresponding descriptive term occurs in the corresponding document.

9. The computer system of claim 8, wherein identifying the principal documents in the cluster (210) comprises generating a document score by summing each row of the matrix using only those columns that correspond with the subset of descriptive terms and comparing a result of the summation to a threshold value.

10. The computer system of claim 1, comprising a staging area (304) configured to receive the principal documents and prepare the principal documents for storage to an information warehouse (302).
